(19) United States
(12) Patent Application Publication
(10) Pub. No.: US 2009/0107107 A1
(43) Pub. Date: Apr. 30, 2009

(54) Multi-function rural fuel platform

(76) Inventor: Peter J. Bell, Addison, TX (US)

Correspondence Address: BRENDAN BABCOCK, 384 NORMANDY CIR, NASHVILLE, TN, 37209, US

(21) Appl. No.: 11/981,148

(22) Filed: Oct. 31, 2007

(51) Int. Cl. F23R 3/00; G06Q 40/00

(52) U.S. Cl. 60/200.1; 705/35

(57) ABSTRACT

A multi function rural fuel platform has a biofuel production unit and a diesel engine incorporated onto a transportable platform, wherein said biofuel production unit produces fuel for said diesel engine.

### CROSS-REFERENCE TO RELATED APPLICATIONS

Not Applicable

### STATEMENT REGARDING FEDERALLY SPONSORED RESEARCH

Not Applicable

### FIELD OF THE INVENTION

This invention relates to a multi function platform which in some embodiments extracts oil from biological sources such as soybeans and produces biofuel from this oil. In addition, the Platform uses the oil to power a diesel engine that can drive a generator to produce electricity, a grinder and a water pump. The electricity produced by the generator can be used for many purposes including running a water purifier, powering electrical circuits and battery chargers.

### BACKGROUND OF THE INVENTION

Multi Function Platforms (MFPs) have been used, but do not provide for the production of fuel that can enable an MFP to be self-supporting and to become an excellent revenue generating system. There remains a need for a multifunction platform that provides fuel production for sale or use in the community it is being produced. The instant invention as disclosed within this application, Multi Function Rural Fuel Platform (MFRFP), provides this and is designed to enable poor, rural farmers to free themselves from the cycle of poverty that currently ensnares them by using biological material as the raw material with which they can energize their communities. The invention allows communities to earn money selling a community produced diesel fuel replacement, and among other things produce electric power and clean water for their community.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### BRIEF SUMMARY OF THE INVENTION

In at least one embodiment, the MFRFP has a biofuel production unit and a diesel engine incorporated onto a transportable platform.

In at least one embodiment, the MFRFP has an oil extraction unit incorporated onto a transportable platform.

In at least one embodiment, the MFRFP has a water purification unit incorporated onto a transportable platform.

In at least one embodiment, the MFRFP has an electric generator incorporated onto a transportable platform.

In at least one embodiment, the MFRFP has a grinding wheel incorporated onto a transportable platform.

In at least one embodiment, the MFRFP has a mill incorporated onto a transportable platform.

In at least one embodiment, the MFRFP has a fluid pump incorporated onto a transportable platform.

In at least one embodiment, the oil extraction unit is an extruder or includes an extruder.

In at least one embodiment, the engine provides heat for a water heater.

In at least one embodiment, the biofuel production unit produces renewable-diesel through thermal cracking.

In at least one embodiment, the MFRFP converts vegetable oils into biofuel without the use of alcohol.

In at least one embodiment, the MFRFP includes a water purification unit. In some embodiments the treated water is contacted with ozone.

In at least one embodiment, the MFRFP includes an oil extraction unit which extracts oil from vegetative matter.

In at least one embodiment, the MFRFP comprises an oil extraction unit, a biofuel production unit, a diesel engine, and a water purification system incorporated onto a transportable platform (will be defined).

In at least one embodiment, the MFRFP includes an oil extraction unit that is an expeller.

In at least one embodiment, the MFRFP is financed through the use of micro bonds and Micro Finance.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawing.

FIG. 1 is a perspective view of an embodied MFRFP.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated. It should be noted that the term “vegetable oil” can also include any biomass oil for use within the diesel engine.

For the purposes of this disclosure, like reference numerals in the figures shall refer to like features unless otherwise indicated.

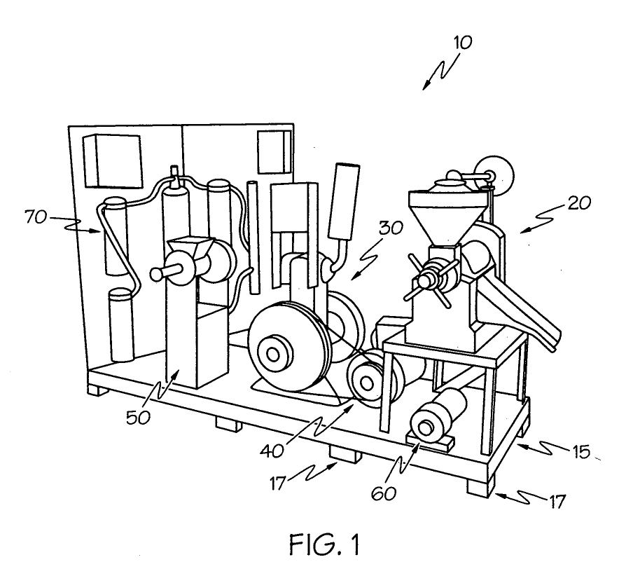

In FIG. 1 an embodied MFRFP 10 is shown. The MFRFP 10 in this embodiment includes a biofuel production unit (e.g. oil processor/oil extraction unit) 20, an electric generator 30, a diesel engine 40, a flour mill 50, a water pump 60, and a water purification system 70. In other embodiments the MFRFP may include other machinery either in addition to those shown or in place of those shown in FIG. 1. In some embodiments the MFRFP 10 has less machinery units such that the platform performs three or fewer functions. In some embodiments only the biofuel production unit 20 and the diesel engine 40 are disposed on the MFRFP. It should be noted that FIG. 1 is illustrative. Multiple types or models could be used in place of any or all of the units shown (e.g. the water purifier need not be wall-mounted and can be a reverse osmosis system, a boiling/condensing system, a chemical system, etc.).

The platform is transportable. A transportable platform is one that can be moved as a unit. In some embodiments the transportable platform can be carried by a standard sized pick-up truck. The invention disclosed in this application includes an embodiment having a transportable platform having machinery thereon that serve different functions. The MFRFP can include a platform 15 mounted on slats 17. In some embodiments the platform is disposed upon wheels and/or skids. In some embodiments the MFRFP can be transported with a forklift or hand cart wherein forks as those on a fork lift can slide under the platform 15 and between slats 17. In some embodiments the MFRFP has a platform size of less than 18 ft². In some embodiments the platform size is between 4 and 30 ft². Larger sizes can also be used, but in some embodiments, the smaller and/or more compact sizes are preferable. In some embodiments the platform 15 has a length between 3 and 15 ft.

Some units that may be used on an embodied MFRFP 10 include, but are not limited to:

Oil processor: The oil processor, in some embodiments, includes an extruder which can crush vegetable oil seeds like Soy (e.g. in the summer) or Canola (e.g. in the winter) and the resulting vegetable oil is then used as fuel for the diesel engine. The protein meal cake left over from the extrusion process can be used to extend the local population's diet and can be used as supplemental animal feed during the cold winter months. Other biomass materials can also be used in the oil extruder other than the seeds of canola, soy, sunflower, jatropha, etc. In some embodiments the MFRFP utilizes algae as a fuel source. Any biomass containing oil may be used in some embodiments.
Diesel engine: The diesel engine can be fueled by the oil produced by the extruder/press of the oil processor and can be used to power the extruder, the electric generator, the water purifier, the water pump, plus provide a small amount heat for home and/or water heating.
Electric generator: The electric generator can enable a local village community to provide power for a village electrification system.
Water pump: The water can pump water from their wells, eliminating the back breaking effort required to carry water by hand.
Water purifier: The water purifier can clean the pumped water with an integrated water purifier system. This may reduce village disease levels caused by contaminated water supplies.
Hot Water: The hot water can be used for personal hygiene or cleaning pots and pans, etc.
Tool and Flour Grinder: The stone grinder provides an excellent tool sharpener for scythes and all the other tools used on the village farms. The flour grinder can save endless hours in food preparation. Saws and other rotating tools can also be incorporated onto the MFRFP.
Rural Fuel Processor: The Rural Fuel Processor converts the vegetable oil produced from the extrusion process and turns it into rural fuel so that the fuel can be sold as a locally produced diesel fuel replacement, generating a hard cash revenue stream for the local population.

The oil can be removed from the biomass in a variety of ways. The oil processor 20 can be an extruder and/or press. In some embodiments an extruder is used for crushing biomass like soy and canola and creating a valuable meal cake and vegetable oil. In some embodiments the oil extracted is passed through a filter either separate from or within the extruder to clean the vegetable oil.

The use of an extruder can produce a high yield of oil without the need for aggressive chemicals like hexane and the oil produced can be ready for human consumption without the need for further refining. The extrusion process also creates a valuable, protein rich meal cake that can be suitable for consumption by humans and animals. The extruder process can also cook the product, gelatinize starch, deactivate anti-nutritional factors and reduce microbial loads purely by heat of friction.

In some embodiments an extruder (in some embodiments a dry extruder), which consists of a screw rotating inside a barrel, can be used. The biomass (e.g. soy seeds) may first be cleaned and cracked into pieces, dehulling may not be necessary. The biomass is fed into the extruder's hopper and conveyed through the extruder. In some embodiments the biomass is at room temperature when they go into the extruder but leave at about 280 degrees F. (range of 140-350 degrees F. in some embodiments) after residing in the extruder for about 25 seconds (the time here can be less or more in some embodiments and is in no way limiting the range of time as other lengths of time can be used successfully). Upon leaving the extruder, the hot oily biomass may be conveyed into an expeller, which is a screw press that squeezes the oil from the biomass.

The vegetable oil produced by the MFRFP can be used as fuel for the MFRFP's diesel engine. Using a locally produced fuel can ensure there is no need to import fuel into the community. Rural communities can therefore use the MFRFP to energize their lives without needing to spend all their income importing fuel to provide that energy.

In addition, the vegetable oil may have many other valuable uses, such as a dietary supplement, feedstock for soap manufacture and cooking oil.

In some embodiments the fuel supplied to the diesel engine is straight vegetable oil (SVO). To use vegetable oil as a fuel to replace petroleum based diesel fuel, you can either modify the engine to deal with the high viscosity of vegetable oil using heat or process the oil to reduce its' viscosity.

In this way the SVO is used in a diesel engine that has been modified so that it heats up the oil before it is used in the fuel system. Typically heating vegetable oil to 150 F can reduce the oil's viscosity sufficiently for use in a diesel engine. In some embodiments the SVO is mixed with petroleum diesel.

In some embodiments a rural fuel processor converts the SVO into biodiesel. Biodiesel is the name of a variety of ester-based oxygenated fuels made from vegetable oils or other biomass oils. The viscosity of the SVO can be reduced such that the engine 30 does not need to preheat the fuel. Biodiesel's viscosity is about twice that of petroleum diesel fuel and its molecular weight is roughly ⅓ of vegetable oil, hence it can be used as a straight petro-diesel replacement. This reduced viscosity vegetable oil is called biodiesel with a number of standards like the European EN 14214 standard and American ASTM standard defining exactly what the properties of that oil should be.

A rural fuel processor can be designed to reduce the viscosity of SVO in a number of ways including but not limited to pyrolysis, catalytically activated vacuum distillation (CAVD), micro emulsion, blending, thermal depolymerization, and transesterification.

One of the most common methods used to reduce oil viscosity in the biodiesel industry is called transesterification. The transesterification refining process can create esters from vegetable oil by using an alcohol in the presence of a catalyst. This reaction takes a triglyceride molecule, or a complex fatty acid, neutralizes the free fatty acids and removes the glycerin, thereby creating an alcohol ester. One method of transesterification mixes methanol with sodium hydroxide and then aggressively mixes the resulting methoxide with vegetable oil, which results in a “Methyl Ester”.

Vegetable oils are a triglyceride and the transesterification reaction process produces, glycerin, methyl stearate, methyl oleate and usually methyl linoleate if soy beans are the feed stock. Once the methoxide and vegetable oil are reacted, the resulting mix of biodiesel and glycerin may then settle using a settling tank. In some embodiments a washing process with water is performed as this additional step may be required to meet all of the ASMT fuel quality standards required for commercial sales of biodiesel.

In at least one embodiment the MFRFP 10 includes a rural fuel processor that utilize a system for the conversion of multiple biomass oil feed stocks into diesel fuel and other combustible products with different boiling temperatures using a catalytic and/or thermal cracking technique.

In at least one embodiment the invention includes a business method for financing the MFRFP in poor communities. In at least one embodiment a “micro” bond is taken out on the entire community or a portion within the community. This is collateral free except for the MFRFP equipment taken back in the case of non payment. The financial risk can be guaranteed by the word of the entire community or those members participating. In at least one embodiment the capital required to finance the MFRFP is raised by one or more persons, perhaps also in poor communities or having limited means. In some embodiments, the investors will be given a rate of return higher that may be higher than that of a savings account.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A multi function rural fuel platform comprising: a biofuel production unit and a diesel engine are incorporated onto a transportable platform, wherein said biofuel production unit produces fuel for said diesel engine.

2. The multi function rural fuel platform of claim 1 having an oil extraction unit incorporated onto the transportable platform.

3. The multi function rural fuel platform of claim 1 having a water purification unit incorporated onto the transportable platform.

4. The multi function rural fuel platform of claim 1 having an electric generator incorporated onto the transportable platform.

5. The multi function rural fuel platform of claim 1 having a grinding wheel incorporated onto the transportable platform.

6. The multi function rural fuel platform of claim 1 having a mill incorporated onto the transportable platform.

7. The multi function rural fuel platform of claim 1 having a fluid pump incorporated onto the transportable platform.

8. The multi function rural fuel platform of claim 2 wherein the oil extraction unit includes an extruder.

9. The multi function rural fuel platform of claim 1 wherein the engine provides heat for a water heater.

10. The multi function rural fuel platform of claim 1 wherein the biofuel production unit produces renewable-diesel through thermal cracking.

11. The multi function rural fuel platform of claim 1 converts vegetable oils into biofuel with an alcohol-free catalytic and/or thermal cracking technique.

12. The multi function rural fuel platform of claim 3 wherein the water purification unit includes contacting the water to be treated with ozone.

13. The multi function rural fuel platform of claim 2 wherein the oil extraction unit extracts oil from biomass matter.

14. A multi function rural fuel platform comprising: an oil extraction unit, a biofuel production unit, a diesel engine, and a water purification system, wherein said oil extraction unit, said biofuel production unit, said diesel engine, and said water purification system are incorporated onto a transportable platform.

15. The multi function rural fuel platform of claim 14 further comprising an electric generator.

16. The multi function rural fuel platform of claim 14 further comprising a grinding wheel.

17. The multi function rural fuel platform of claim 14 further comprising a mill.

18. The multi function rural fuel platform of claim 14 further comprising a fluid pump.

19. The multi function rural fuel platform of claim 14 wherein the oil extraction unit includes an expeller.

20. A business method for financing the multi function rural fuel platform of claim 1 comprising taking a bond out on a community or group of people in exchange for the multi function rural fuel platform, the bond is then financed by investors receiving an agreed upon return on investment.
